(19) United States
(12) Patent Application Publication
(10) Pub. No.: US 2010/0332593 A1
(43) Pub. Date: Dec. 30, 2010

(54) SYSTEMS AND METHODS FOR OPERATING AN ANTI-MALWARE NETWORK ON A CLOUD COMPUTING PLATFORM

(76) Inventors: Igor Barash, Los Angeles, CA (US); Gary Guseinov, Los Angeles, CA (US); Achal S. Khetarpal, Los Angeles, CA (US); Bing Liu, Los Angeles, CA (US); Serge Zilber, Los Angeles, CA (US)

Correspondence Address: CHRISTIE, PARKER & HALE, LLP, PO BOX 7068, PASADENA, CA, 91109-7068, US

(21) Appl. No.: 12/826,583

(22) Filed: Jun. 29, 2010

Related U.S. Application Data
(60) Provisional application No. 61/221,477, filed on Jun. 29, 2009.

(51) Int. Cl. G06F 15/16

(52) U.S. Cl. 709/203

(57) ABSTRACT

Systems and methods for operating an anti-malware network on a cloud computing platform are provided. In one embodiment, the invention relates to a method for distributing files using a cloud for providing computing services, the method including providing, at the cloud, cloud services including a data structure and a virtual machine, obtaining, from the data structure in the cloud, information including at least one location of a file available for distribution, obtaining, at a client computer, the file from the at least one location.

### CROSS REFERENCE TO RELATED APPLICATIONS

The present application claims the priority to and the benefit of U.S. Provisional Application No. 61/221,477, filed Jun. 29, 2009, entitled “SYSTEM AND METHOD FOR OPERATING AN ANTI-MALWARE NETWORK ON A CLOUD COMPUTING PLATFORM”, the entire content of which is incorporated herein by reference.

### FIELD

The present invention relates to a file distribution system for protecting computers from threats that can be spread over a computer network and more specifically to systems and methods for operating an anti-malware network on a cloud computing platform.

### BACKGROUND

Networks such as the Internet enable rapid communication of information between computers. Unfortunately, the capability of computers to communicate is often used to victimize computer systems and/or their users. A variety of known threats exist that are spread using networks. One example of a threat is a computer virus. Computer viruses are programs that typically seek to reproduce themselves and can also modify and/or damage a computer system. Another threat to a computer user is Phishing. Phishing schemes (also known as carding and spoofing) typically seek to fraudulently acquire sensitive information, such as passwords and/or credit card details, by masquerading as a trustworthy person or business in an apparently official electronic communication, such as an email, a web page or an instant message. Another type of threat is Spam. Spamming is the sending of unsolicited email messages in bulk. Spam usually does not represent a significant risk to a computer, however, large volumes of Spam can congest networks, result in increased email server costs and reduce the efficiency of computer operators.

Spyware is another type of threat. Spyware is a broad category of malicious software intended to intercept or take partial control of a computer's operation without the user's informed consent. While the term taken literally suggests software that surreptitiously monitors the user, it has come to refer more broadly to software that subverts the computer's operation for the benefit of a third party. Examples of Spyware include software designed to deliver unsolicited pop-up advertisements (often referred to as “adware”) and software that steals personal information (often referred to as “stealware”). Spyware as a class of threat is very broad and is difficult to characterize. Although not always the case, Spyware typically does not seek to reproduce and in this regard are often distinct from viruses.

Another type of threat is hijacking. There are generally considered to be two classes of hijacking. Client hijacking is a term used to describe a threat involving a piece of software installed on a user's computer to hijack a particular application such as a search. Examples of client hijacking include redirecting a user from a known website to another website or appending affiliate information to a web search to generate revenue for the hijacker. A second class of hijacking is referred to as server hijacking. Server hijacking involves software that hijacks a server and usually involves hijacking a web site. The server hijacking may involve a simple redirection of traffic to the website or could be the redirection of results generated by a search engine. Yet another type of threat is automated hacking. Automated hacking typically involves a computer program that is installed on the computer. Once the program is installed the program will attempt to steal confidential information such as credit card numbers and passwords.

Computers can run software that is designed to detect threats and prevent them from causing harm to a computer or its operator. Often, threat signatures are used to identify threats. A threat signature is a characteristic of a threat that is unique and, therefore, distinguishes the threat from other potentially benign files or computer programs (e.g., a file name). A limitation of systems that use threat signatures to detect threats is that these systems do not, typically, possess a threat signature for a previously unknown threat. The lack of a threat signature can be overcome by attempting to identify a new threat as soon as it manifests itself Once the threat is identified, a threat signature can be generated for the threat and the new threat signature distributed to all of the computers in the threat protection system. In the case of mass spreading threats (i.e. threats designed to spread to a large number of computers very rapidly), the number of computers that fall prey to the threat is typically dependent upon the time between the threat first manifesting itself and the distribution of a threat signature.

Systems and methods for detecting threats in a real-time fashion and distributing threat protection software have been proposed. For example, U.S. patent application Ser. No. 11/233,868, entitled “SYSTEM FOR DISTRIBUTING INFORMATION USING A SECURE PEER-TO-PEER NETWORK”, the entire content of which is incorporated by reference herein, describes a system for distributing files, including, for example, threat protection software. U.S. patent application Ser. No. 11/234,531, entitled “THREAT PROTECTION NETWORK”, the entire content of which is incorporated by reference herein, describes a system for detecting and protecting against various threats. Such systems commonly include one or more servers that can fail. In some instances, the failures can be caused by reliability issues of the servers. In other instances, the failures can be caused by an overload of requests from clients. In still other instances, malicious clients or other computers having access to the server can bring the servers down. Accordingly, a system and method for overcoming these failures is desirable.

### SUMMARY

Aspects of the present invention relate to systems and methods for operating an anti-malware network on a cloud computing platform. In one embodiment, the invention relates to a method for distributing files using a cloud for providing computing services, the method including providing, at the cloud, cloud services including a data structure and a virtual machine, obtaining, from the data structure in the cloud, information including at least one location of a file available for distribution, obtaining, at a client computer, the file from the at least one location.

In another embodiment, the invention relates to a file distribution system using a cloud for providing computing services, the system including a cloud coupled to a network, the cloud configured to provide cloud computing services and including a data structure and a server application, a plurality of client computers coupled to the network, each client computer configured to store a request for a file in the data structure, wherein the server application is configured to retrieve the request from the data structure and to provide, for each client computer requesting the file, information for obtaining the file.

In yet another embodiment, the invention relates to a method for distributing files using a cloud for providing computing services, the method including obtaining an updated index file from a cloud storage, parsing the updated index file for at least one name of an updated distribution file, determining, for the at least one name, whether a queue for the at least one name exists in the cloud, determining, if the queue exists, whether the queue is empty, obtaining, if the queue is empty, the updated distribution file from the cloud storage, and obtaining, if the queue is not empty, the updated distribution file from a client computer.

In still yet another embodiment, the invention relates to a file distribution system using a cloud for providing computing services, the system including: a cloud coupled to a network, the cloud configured to provide cloud computing services and including a data structure and a server application having a file storage, a plurality of client computers coupled to the network, each client computer configured to communicate a request for a file to the data structure, wherein the server application is configured to respond to the request by providing information identifying at least one of the plurality of client computers having the file, wherein each of the plurality of client computers is configured to obtain the file from the identified client computer, wherein a first client computer of the plurality of client computers is configured to obtain the file from the file storage if the first client computers is unable to obtain the requested file information from the identified client computer.

### BRIEF DESCRIPTION OF THE DRAWINGS

FIG. 1 is a schematic block diagram of a system for distributing files using a cloud computing platform in accordance with one embodiment of the invention.

FIG. 2 is a flowchart illustrating a method for distributing files using a cloud computing platform in accordance with one embodiment of the invention.

FIG. 3 is a schematic block diagram of a system and method for operating an anti-malware network on a cloud computing platform in accordance with one embodiment of the invention.

FIG. 4 is a schematic block diagram showing the flow of data across applications of the anti-malware network of FIG. 3.

FIG. 5 is a schematic block diagram showing the flow of data across components of the SpnAdmin system and a client computer of FIG. 3.

FIG. 6 is a flowchart illustrating a client update process that can be performed on a client computer in accordance with one embodiment of the invention.

FIG. 7 is a flowchart illustrating another client update process that can be performed on a client computer in accordance with one embodiment of the invention.

FIG. 8 is a flowchart illustrating a client checkup process that can be performed on a client computer in accordance with one embodiment of the invention.

FIG. 9 is a flowchart illustrating an secure peer network (SPN) update process that can be performed on a cloud virtual machine in accordance with one embodiment of the invention.

FIG. 10 is a flowchart illustrating an secure peer network (SPN) index process that can be performed on a cloud virtual machine in accordance with one embodiment of the invention.

FIG. 11 is a schematic block diagram showing the flow of data across components of the VirusAdmin system and a client computer of FIG. 3.

FIG. 12 is a schematic block diagram showing the flow of data in and out of the VirusAdmin system of FIG. 11 in accordance with one embodiment of the invention.

### DETAILED DESCRIPTION OF THE INVENTION

Cloud computing is one of the most advanced technologies in the computer/Internet area in recent years. Basically cloud computing provides two great advantages over the traditional computer network model. First, the computer system (e.g., CPU plus memory plus storage plus software) is no longer a physical device. In the cloud, a user or software service provider can create as many virtual computers as needed and pay a usage fee just like a company uses electric or gas service and pays the bill based on the usage. Also, a company or user does not need to worry about a replacement or a re-build of a physical computer system as a new virtual computer can be started any time (e.g., after a failure of a computer in the system). Second, the cloud provides generic web services based on the cloud computing platform such as database service, storage service and messaging service. So a company does not need to host company data and company service software on company owned systems anymore. This significantly changes the software architecture for a software system to be located in the cloud.

Embodiments of the present invention provide systems and methods for distributing files using cloud services provided by a cloud services provider. The cloud services include a data structure, a virtual machine, and other useful computing services. A client computer can obtain, from the data structure in the cloud, information including a location of a file available for distribution. In one embodiment, the location is a storage service provided by the cloud services provider. In another embodiment, the location is a another client computer having the desired file. The client computer can obtain the file from the indicated location. In a number of embodiments, the client computers can only communicate with applications running on a virtual machine provided by the cloud (e.g., virtual server) by way of one or more data structures effectively forming a data abstraction layer. In such case, the virtual server is protected from malicious attacks from client computers. In addition, the cloud services, including the number and size of data structures and virtual machines allocated, are dynamically scalable to accommodate changes in client demand, network bandwidth and other factors.

In a number of embodiments, the file distribution system is extended to operate in conjunction with an anti-malware network on a cloud computing platform. In one such embodiment, the system includes a cloud coupled by a network to a number of client computers. The cloud provides cloud computing services including data structures and a server application having a file storage. The client computers are configured to communicate requests for a file to the data structure. The server is configured to respond to the requests by providing information identifying a client computer having the desired file. The requesting client computer can attempt to obtain the desired file from the identified client computer. In the event the requesting client computer is unable to obtain the file from the identified client computer, the requesting client computer can attempt to obtain the file from the file storage in the cloud.

In many embodiments, the communication between the cloud applications and client computers is indirect and is facilitated through any number of messaging queues or other data structures. The messaging queues and other cloud data structures can serve multiple purposes in system. As communication with the application modules or virtual servers in the cloud is typically only via the data structures, the application modules are protected from attacks from malicious clients or other computers on the network. Also, the data structures can be used as a feedback mechanism to the clients regarding the state or capacity of the system. For example, when various messaging queues in the system are full, a client contacting those queues is notified and can wait a preselected period of time before returning to inquire or make a request through a messaging queue. In this way, a client throttling mechanism is provided in using the cloud data structures in the anti-malware network.

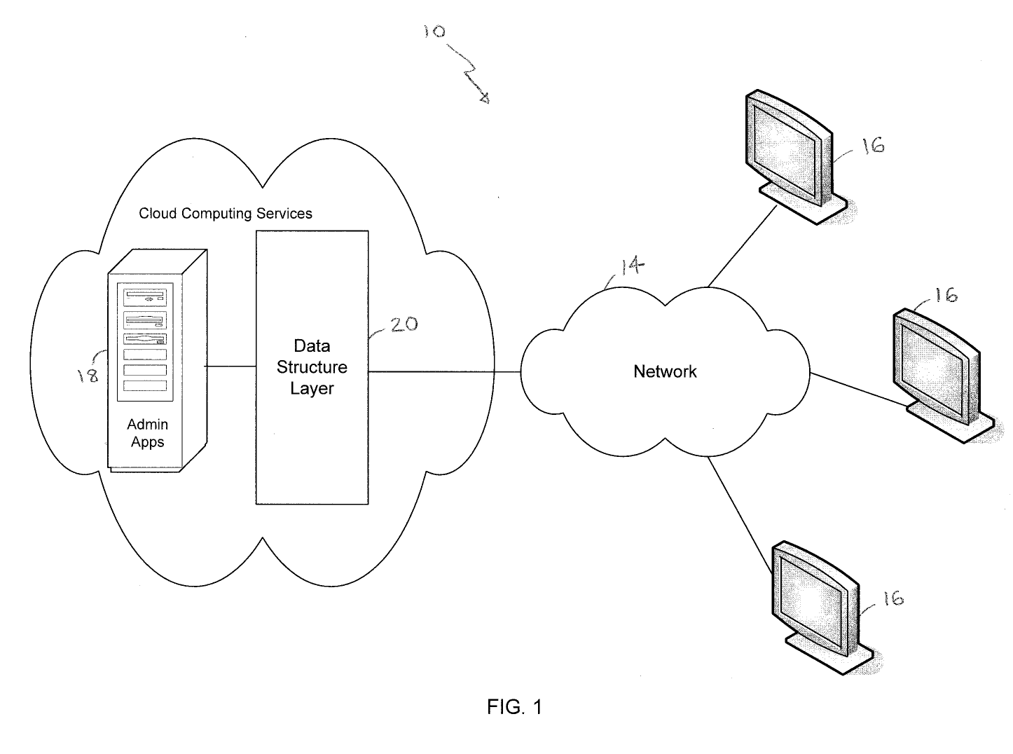

FIG. 1 is a schematic block diagram of a system for distributing files using a cloud computing platform in accordance with one embodiment of the invention. The system 10 includes a cloud providing cloud services 12 coupled to a network 14. The network 14 is coupled to three client computers 16. The cloud 12 includes a virtual machine or server 18 for running administrative or control applications and a data structure layer 20. The data structure layer 20 is positioned between the virtual server 18 and the network 14. The data structure layer 20 can include queues, databases, storage, and other suitable data structures. The virtual server 18 can include one or more virtual machines. In one embodiment, the cloud services are provided as Amazon Web Services by Amazon.com Inc. of Seattle, Wash. In a number of embodiments, the network is the Internet. In other embodiments, the network can be another network such as a private network. In FIG. 1, the system include three client computers 16. In other embodiments, the system can include more than or less than three client computers.

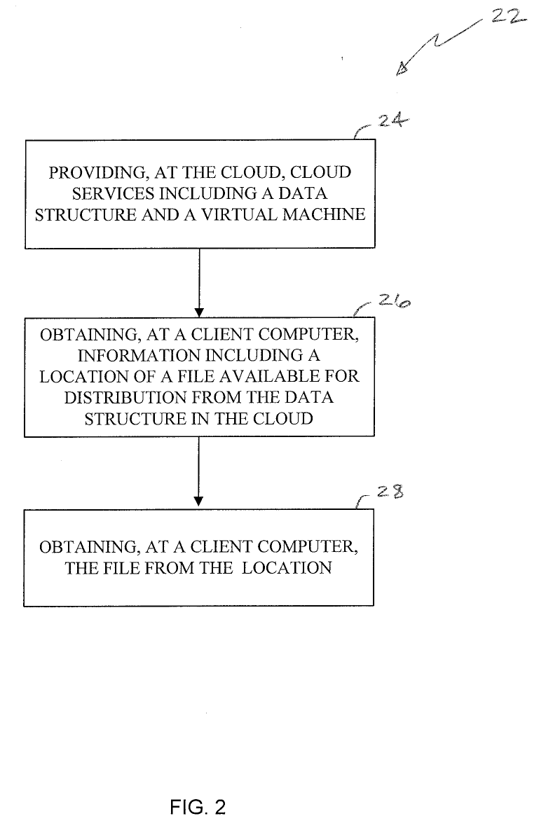

FIG. 2 is a flowchart illustrating a process for distributing files using a cloud computing platform in accordance with one embodiment of the invention. In one embodiment, the process 22 is used in conjunction with the file distribution system of FIG. 1. The process 22 first provides (24), at a cloud, cloud services including a data structure and a virtual machine. The process then obtains (26), at a client computer, information including a location of a file available for distribution from the data structure in the cloud. The process obtains (28), at the client computer, the file from the specified location. In several embodiments, the specified location is a database or other virtual storage component in the cloud. In other embodiments, the specified location is a another client computer having already acquired the desired file.

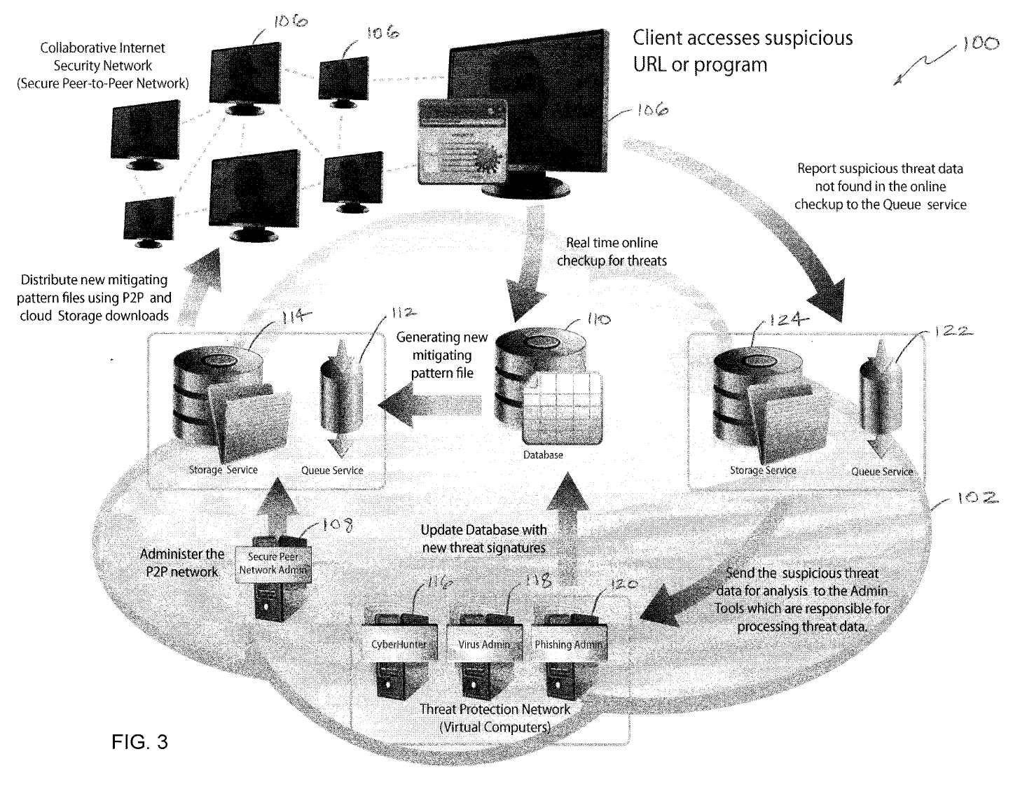

FIG. 3 is a schematic block diagram of a system and method for operating an anti-malware network on a cloud computing platform in accordance with one embodiment of the invention. The anti-malware network 100 includes a cloud 102 providing a number of cloud services coupled by a network (not shown) to multiple client computers 106. The client computers 106 communicate with a number of data structure components in the cloud 102. The cloud services provided by cloud 102 include a virtual machine configured as a Secure Peer Network (SPN) Admin system 108 that communicates indirectly with clients 106 via database 110, message queue 112 and storage 114. The cloud services provided by cloud 102 also include a threat protection network module including a CyberHunter system 116, a VirusAdmin system 118 and a PhishingAdmin system 120. The threat protection network is not directly available to the clients 106 but is indirectly available through messaging queues 122 and storage 124.

In operation, the client computers 106 can perform a checkup to determine whether they have the latest threat definition files or other distributed files by querying database 110, queue 112, and/or storage service 114. The SPN Admin virtual machine will work with the client computers 106 through the data structures to answer the query and provide information for obtaining any necessary updates to the threat definition files. The threat definition files can include a virus definition file, a malicious URL definition file, a non-malicious or benign definition file, and other appropriate definition files. The client computers 106 can download the updated files from other client computers 106 or, if the client computers are unavailable or not in possession of the requested files, from cloud storage.

The client computers 106 can also report suspicious threat files/data, not found in local threat databases or in threat databases in the cloud, to cloud storage 124 and queue 122. The reported threat files can be analyzed by the threat protection network applications such as Virus Admin 118, CyberHunter 116 or Phishing Admin 120. The Virus Admin application 118 can include a AppHunter thread that analyzes a reported threat file by experimentation on one or more test computers. The Phishing Admin application 120 can analyze specific threat files such as uniform resource location (URL) files and can analyze the behavior of websites corresponding to the URLs. The CyberHunter application 116 can crawl the Internet analyzing various random and targeted websites for malicious and non-malicious behavior. The analysis can extend to website components, links, and associated content. If malicious websites and/or threat files are found by CyberHunter they can be added to the appropriate databases or storages in the cloud. In addition, CyberHunter can refer files to other applications for analysis, including, for example, the Virus Admin application.

The network architecture of the anti-malware network is similar to that of a peer to peer network. However, it may be better characterized as a hybrid peer to peer network which includes a server for initial seeding purposes. In contrast to file sharing systems typically employing peer to peer networks, several embodiments of the anti-malware systems described herein seek to distribute updated threat definition files and client executable software files rather than files specified by a user of a client computer. In addition, distribution files can originate on the server applications rather than on any client computer.

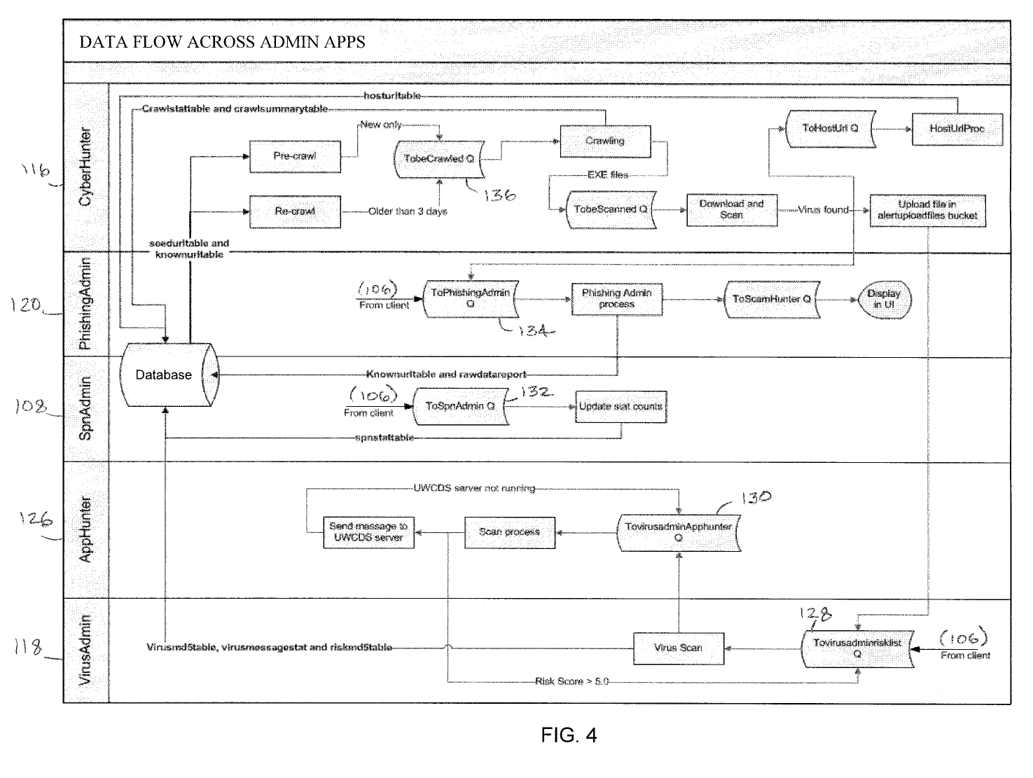

FIG. 4 is a schematic block diagram showing the flow of data across applications of the anti-malware network of FIG. 3. Each of the applications include a number cloud provided data structures for communicating between applications and the client computers. For example, the VirusAdmin application 118 includes a queue named “Tovirusadminrisklist” 128, which can receive information on potential threat files/data for analysis from client computers 106 or the CyberHunter application 116. The AppHunter application 126 includes a queue named “TovirusadminAppHunter” 130 which can receive messages regarding threat files to be tested. The AppHunter application 126 can be a thread of the Virus Admin application 118 or an independent application. The SPN Admin application 108 includes a queue named “ToSpnAdmin” 132 which can receive messages from a client computer 106 regarding the availability of the client computer for peer-to-peer downloads by other client computers. The Phishing Admin application 120 includes a queue named “ToPhishingAdmin” 134 which can receive messages from a client computer 106 or CyberHunter 116 regarding a suspicious URL for analysis. The CyberHunter application 116 includes a queue named “TobeCrawled” 136 which can receive messages from various tables specifying websites to be analyzed for threats.

In FIG. 4, the applications use various queues to exchange messages to facilitate the management and analysis of threat files and other threats. In other embodiments, other suitable data structures can be used. In addition, while specific queues and table names are indicated in FIG. 4, additional queues, tables and other data structures can be used but may not be illustrated.

VirusAdmin Application:

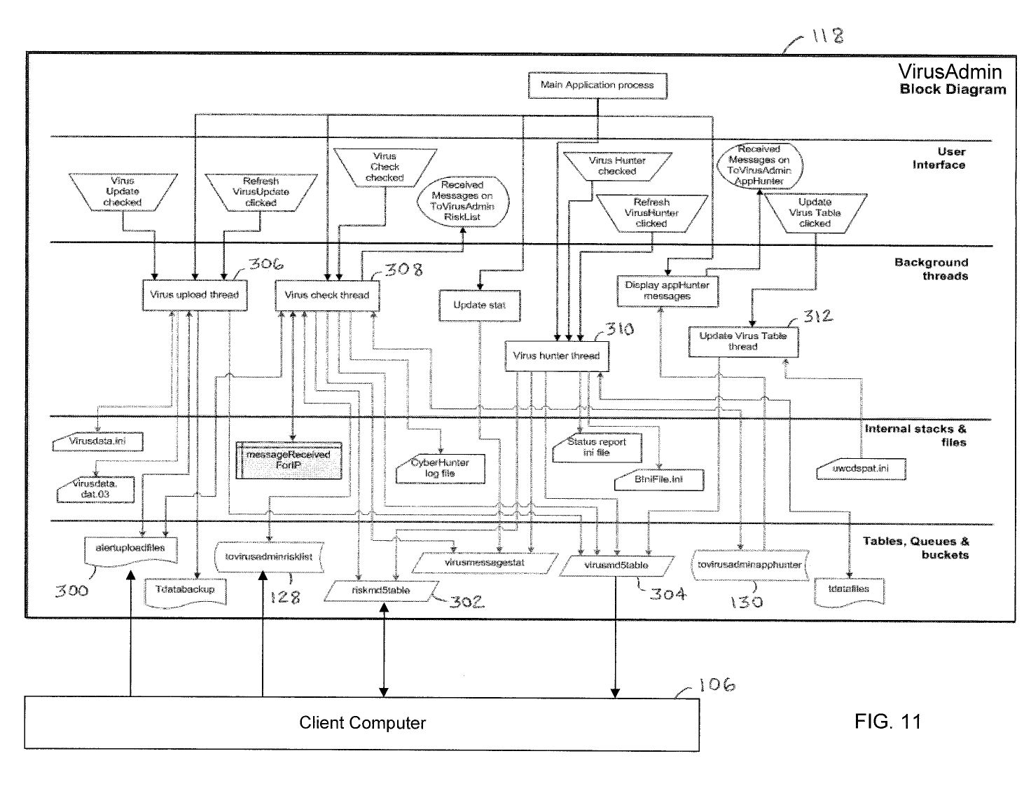

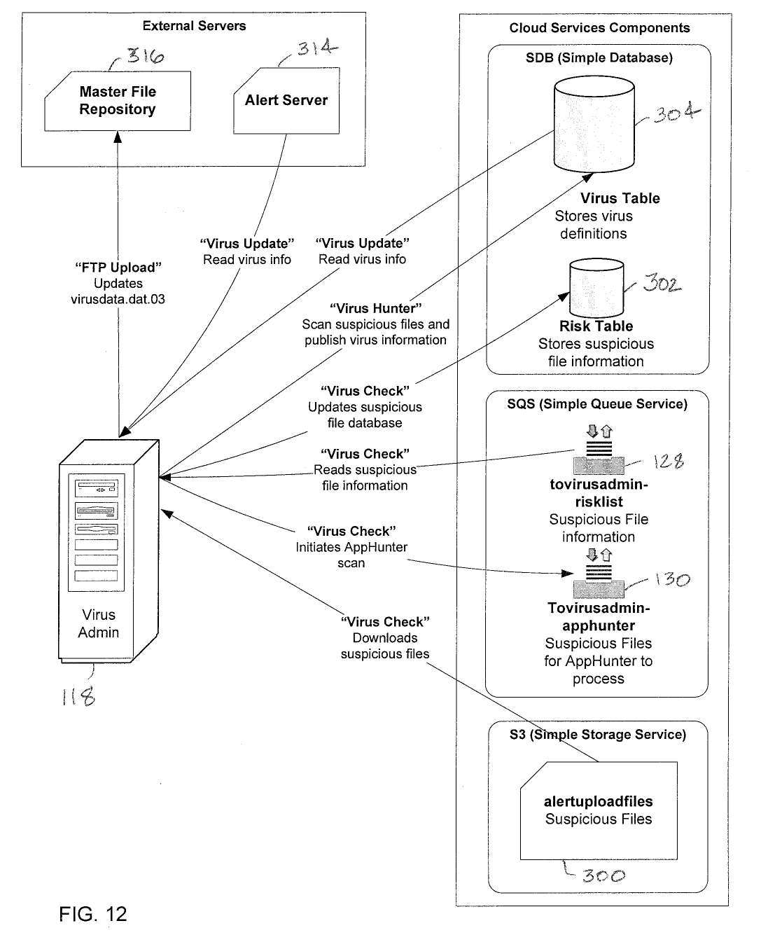

In one embodiment, VirusAdmin is a multi-threaded program that creates a virus data database, a virus reporting queue, an AppHunter queue, risk file storage and a virus data file storage in the cloud. A thread can read and remove messages from the virus reporting queue. If the message data contains virus signatures sent by AppHunter, then the thread can add the signatures into the virus database. If the message data contains risk file information, VirusAdmin can download the risk file from the risk file storage and let AppHunter system analyze the risk file. If AppHunter identifies the risk file as a virus file, then VirusAdmin can add its file signatures into the virus database. In such case, it can also send the suspicious file information into the AppHunter queue to let AppHunter further analyze the suspicious file in a test computer. Another thread can generate a new virus data file and add it into the virus data file storage. Further discussion of the VirusAdmin application follows in the description of FIGS. 11-12.

AppHunter Application:

In one embodiment, AppHunter runs on the test computer. This application can read and remove messages from the AppHunter queue in the cloud. AppHunter can use the message data to download a referenced risk file from risk file storage and analyze run-time behaviors of the risk file. If it is determined to be a virus file based on the run-time behavior, AppHunter can report its file signatures to the virus reporting queue.

PhishingAdmin Application:

In one embodiment, PhishingAdmin is a multi-thread program and creates a phishing URL database, a suspicious URL database, a malware URL database, a phishing/malware reporting queue and phishing/malware data file storage in the cloud. A thread can read and remove messages from the phishing/malware reporting queue and use the message data to analyze the reported URL. If the URL is identified by the detection rules, it can be added into the phishing/malware data database. If the URL is not identified, it can be added into the suspicious URL database for interactive threat analysis by a TPNReport program. Another thread can generate new a phishing/malware data file and add it into the phishing/malware data file storage.

CyberHunter Application:

In several embodiments, CyberHunter crawls websites to identify suspicious threat data and malware files, analyzes and generates new threat data that is stored in a threat data database in the cloud. In one embodiment, CyberHunter is a multi-thread program that creates a seed URL database, a bad-host URL database, a crawl-stat database, a crawl queue, a scan queue, a bad-host queue and crawl-log storage. A thread can check the seed URL database and the malware URL database and add any new sites into the crawl queue. A thread can read and remove a message from the crawl queue and then crawl web pages based on the site name in the message. The thread can also add new site names called cross sites into the seed URL database if they do not already exist. It can also add the file URL if it is a live page into a scan queue. Another thread can read and remove a message from the scan queue and then download the file to check if it is virus. If the file is a virus, CyberHunter can add the host URL into the bad-host queue. Another thread can read and remove messages from the bad-host queue and write bad-host information into the bad-host URL database. Another thread can generate a crawl log file from crawl-stat database and add the information to a crawl stat log storage.

The client computer, SPN Admin, and Virus Admin applications are described further below.

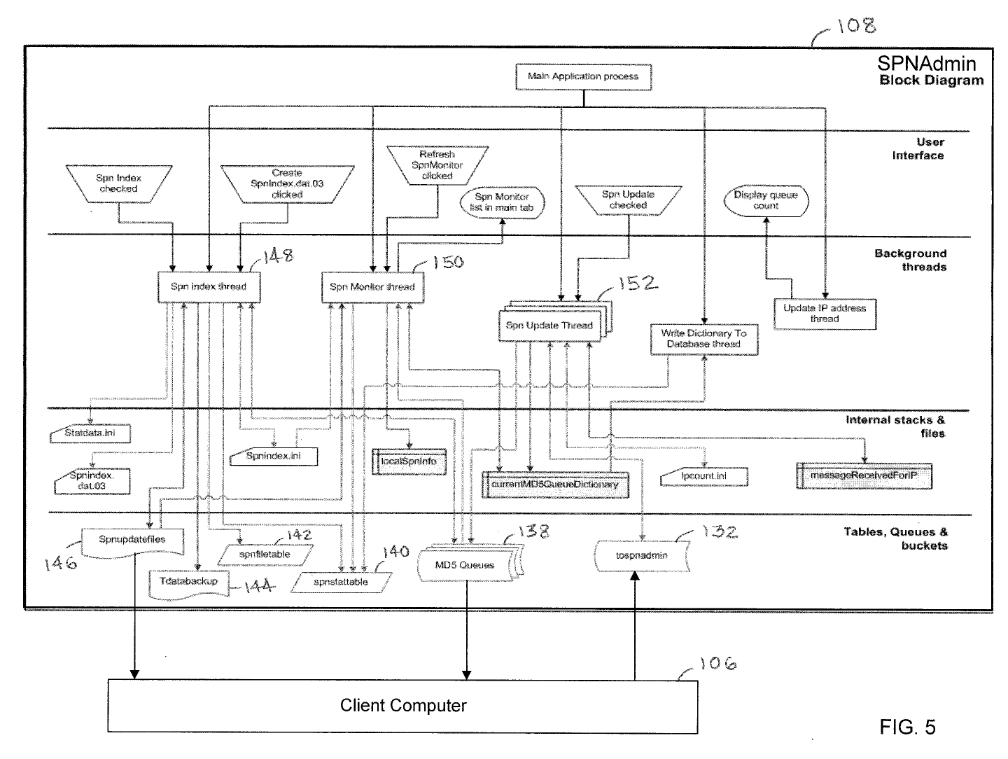

FIG. 5 is a schematic block diagram showing the flow of data across components of the SpnAdmin system 108 and a client computer 106 of FIG. 3. The SPNAdmin system 108 includes the tospnadmin queue 132, peer download queues (“MD5 Queues”) 134, a SPN statistics table named “spnstattable” 140, a file table named “spnfiletable” 142, a storage bucket named “Tdatabackup” 144, and a storage bucket named “Spnupdatefiles” 146. In a number of embodiments, the SPNAdmin cloud storage components are created by the SPNAdmin application. The SPNAdmin system 108 also includes multiple threads including a Spn Index thread 148, a Spn Monitor thread 150, and a Spn Update thread 152.

The SPN Index thread 148 can upload index file (e.g., file “spnindex.ini”) and various software updates to the appropriate storage locations. Further discussion of the SPN Index thread 148 follows. The Spn monitor thread 150 tracks and updates statistics associated with operation of the applications running in the cloud and stores the information in tables such as the “spnstattable” 140 and other data structures. These statistics can be presented in a user interface for an operator or system administrator. The Spn Update thread 152 provides and manages information on client computers that can service file transfer requests between the clients computers. Further discussion of the SPN Update thread 152 follows.

The files stored and exchanged with the cloud and client computers can be identified by a key name which is an MD5 code appended by size of file. For example, the key name “0E691B3F7E9DC590A77D730C8C4CBA201314146” can represent a file where “0E691B3F7E9DC590A77D730C8C4CBA20” is the MD5 code and “1314146” is the size of the file.

The “tospnadmin” queue can receive a number of messages the client computers. In one embodiment, the format of a message received can be “IP, Port, MD5 code, Flag for download” or “IP, Port, MD5 code, Flag for download, Src-IP, Src-Port”. In such case, the “tospnadmin” queue can receive the message in the first format when the “Flag for download” field has value “1” and otherwise can receive the message in the second format. In one embodiment, this can create queues with the MD5 code based on the received message on the “tospnadmin” queue. The message format which is sent to these MD5 queues is generally “IP, Port”. These values can be extracted from the message received on “tospnadmin” queue.

In the embodiment illustrated in FIG. 5, SpnAdmin creates the table named “spnfiletable”. This table can contain a File Location, a File Type and an Upload time stored in columns. In one embodiment, SpnAdmin also creates the table named “spnstattable”. This table can contain a MD5 code, a FileSize, a URL, a Date Time, an Upload Date time, a Total from cloud storage and a Total from download queues as columns. In such case, the MD5 code can represent the MD5 code of file uploaded to cloud storage, the FileSize can represent an actual file size, the URL can represent a location from where a particular file is downloaded, the Date Time can represent the current time when the record is being added, the Upload Date time can represent the time at which the file was uploaded to cloud storage, Total from cloud storage and Total from queues can represent the number of downloads completed from the cloud storage database and from the download queues (e.g., from client computers), respectively.

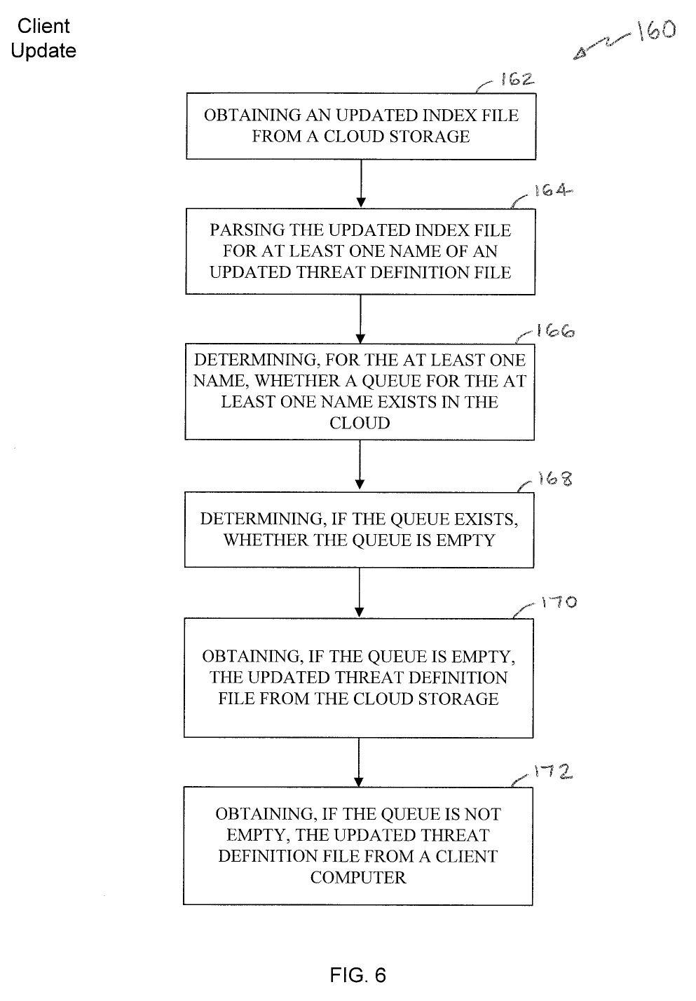

FIG. 6 is a flowchart illustrating a general client update process 160 that can be performed on a client computer in accordance with one embodiment of the invention. The process first obtains (162) an updated index file from a cloud storage component. In one embodiment, the index file is the “spnindex.ini” file and the cloud storage component is the “spnupdatefiles” bucket. The process then parses (164) the updated index file for the names of any updated threat definition files or other appropriate update files to be downloaded. The process then determines (166), for each of the named update files, whether a queue for the named update file exists in the cloud. The process then determines (168), if the queue exists, whether the queue is empty. If the queue is empty, the process obtains (170) the updated threat definition file from the cloud storage. If the queue is not empty, the process obtains (172) the updated threat definition file from a client computer.

In one embodiment, the process can perform the sequence of actions in any order. In another embodiment, the process can skip one or more of the actions. In other embodiments, one of more of the actions are performed simultaneously. In some embodiments, additional actions can be performed.

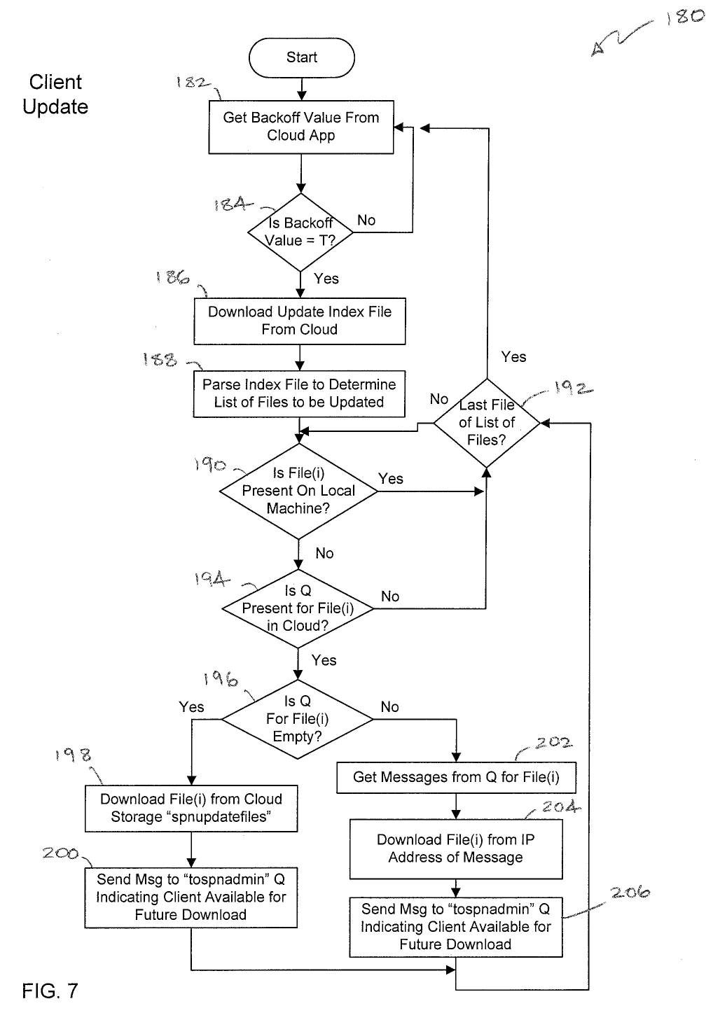

FIG. 7 is a flowchart illustrating another client update process 180 that can be performed on a client computer in accordance with one embodiment of the invention. The process first gets (182) a backoff value from a cloud application or storage component. In one embodiment, the backoff value is controlled by the SPN Admin application. The process then determines (184) whether the backoff value is true. If it is not true, then the process returns to getting (182) the backoff value or effectively waiting. The backoff value can be used by cloud applications, including SPN Admin, as a way to throttle or scale back demands/requests from the client computers.

The process then downloads (186) an updated index file from the cloud. In one embodiment, the index file is the “spnindex.ini” file and the cloud storage component is the “spnupdatefiles” bucket. The process can then parse (188) the index file to determine a list of files that need to be updated. For each file in the list, File(i), the process can perform the following actions. The process can determine (190) whether File(i) is present on the local client computer. If so, the process determines (192) whether File(i) is the last file in the list of files. If so, the process returns to getting (182) the backoff value. If File(i) is not the last file, the process moves on to the next file in the list and determines (190) whether File(i) is present on the local client computer. If the File(i) is not present on the local machine, the process determines (194) whether a queue is present for the particular File(i) in the cloud. If not, the process the process returns to determining (192) whether File(i) is the last file in the list of files. If the queue is present, the process determines (196) whether the queue for File(i) is empty.

If the File(i) queue is empty, the process downloads (198) the File(i) from the cloud storage bucket named “spnupdatefiles”. The process then sends (200) a message to the “tospnadmin” queue indicating the instant client computer is available for future file downloads via the SPN network. The message includes including information about accessing the client computer on the network. The process then returns to determining (192) if File(i) is the last file.

If the File(i) queue is not empty, the process can get (202) a message from the queue. The process can then download (204) File(i) using an internet protocol (IP) address contained in the message. The process then sends (206) a message to the “tospnadmin” queue indicating the instant client computer is available for future file downloads via the SPN network. In several embodiments, the process indicates in the message to the “tospnadmin” queue whether the client computer obtained the file from cloud storage or from another client computer. The process then returns to determining (192) if File(i) is the last file.

In one embodiment, the process can perform the sequence of actions in any order. In another embodiment, the process can skip one or more of the actions. In other embodiments, one of more of the actions are performed simultaneously. In some embodiments, additional actions can be performed.

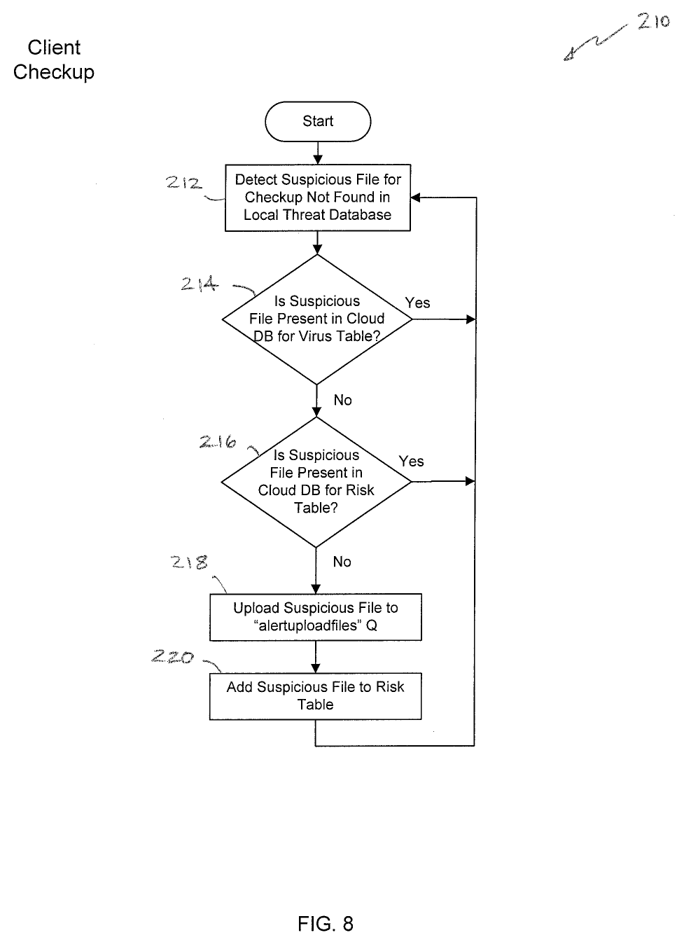

FIG. 8 is a flowchart illustrating a client checkup process 210 that can be performed on a client computer in accordance with one embodiment of the invention. The process first detects (212) a suspicious file that is not found in a local threat database/file of the client computer. In several embodiments, the process detects the suspicious file based on suspicious file behaviors, such as those described in U.S. patent application Ser. No. 11/234,531, entitled “THREAT PROTECTION NETWORK”, which describes a system for detecting and protecting against various threats. The process then determines (214) whether the suspicious file is present in a cloud database for a virus table. The virus table can be a table listing the names or signatures of known virus files. If so, the process returns to detecting (212) suspicious files. If the suspicious file is not present in the virus table, the process determines (216) whether the suspicious file is present in a cloud database for a risk table. The risk table can be a table listing the names or signatures of known suspicious files. If the suspicious file is present in the risk table, then the process returns to detecting (212) suspicious files as another client or cloud application has apparently already reported the suspicious file. If the suspicious file is not present in the risk table, then the process uploads (218) the suspicious file. In several embodiments, the process uploads a signature of the suspicious file consisting of a hash coded version of the suspicious file such as a “MD5” hash coded file, to a cloud storage queue named “alertuploadfiles” maintained by the VirusAdmin application. The process then adds (220) the suspicious file to the risk table. In some embodiments, the process adds the suspicious file to a queue rather than writing directly to the risk table. The process can then return to detecting (212) suspicious files.

In a number of embodiments, the client computer processes only have read access to cloud storage components. In such case, information is provided to cloud applications from the client computers by way of queues to which the client computers can write data. In other embodiments, the client computers have limited write access to some cloud storage components such as the risk table.

In one embodiment, the process can perform the sequence of actions in any order. In another embodiment, the process can skip one or more of the actions. In other embodiments, one of more of the actions are performed simultaneously. In some embodiments, additional actions can be performed.

In one embodiment for example, the client software also blocks, protects and reports phishing/malware found on the client computer. The client software can use a local phishing/malware data file to verify every URL that is about to be accessed. If the URL matches an entry in the local phishing/malware data file, the client software can redirect the user to a warning page to temporarily block access to, or a download from, that URL. After accessing or downloading a new web page, the client software can use its own detection rules to identify any new suspicious phishing/malware URL. If the client software finds any suspicious or newly identified phishing/malware URL, it can check to see whether a phishing/malware reporting queue in the cloud is full or not. If the phishing/malware reporting queue is not full, the client software can send a message with the URL data and client computer information such as its IP location to be stored in the phishing/malware reporting queue.

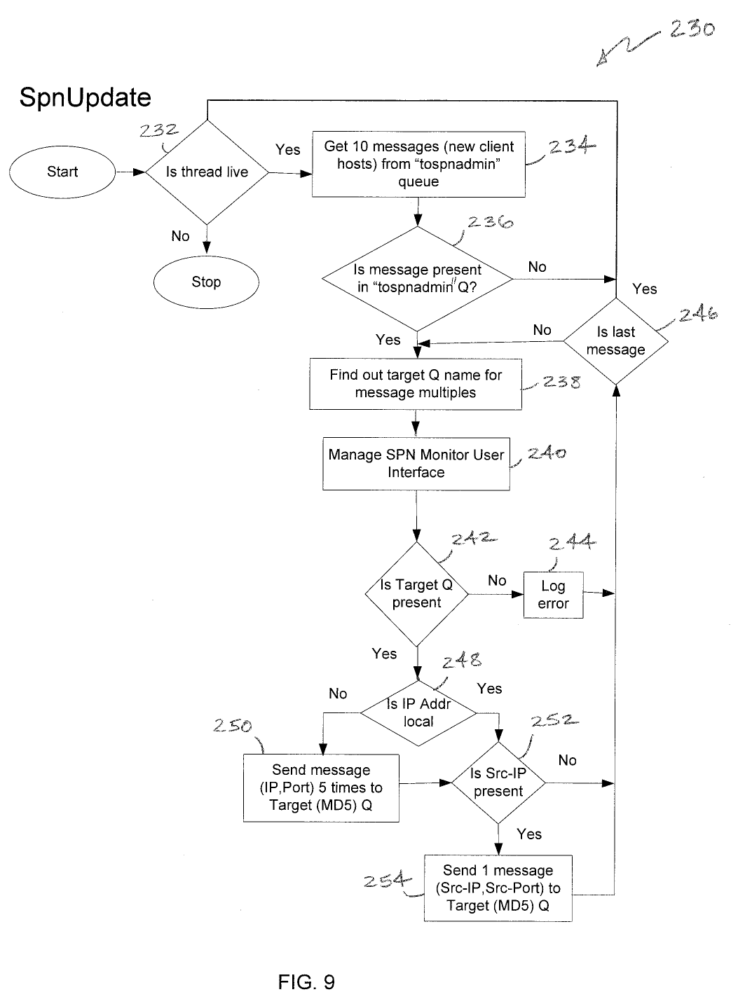

FIG. 9 is a flowchart illustrating an secure peer network (SPN) update process 230 that can be performed on a cloud virtual machine in accordance with one embodiment of the invention. The process first determines (232) whether the thread is live. If it is not, the process stops. If it is live, the process gets (234) ten messages (indicative of new client hosts) from the “tospnadmin” queue. In other embodiments, the process can get more than or less than ten messages. Proceeding message by message for the ten messages, the process determines 236 whether a first message is present in the “tospnadmin” queue. If not, the process returns to determining (232) whether the thread is live. If so, the process determines (238) a target queue name for message multiples or duplicates.

The process can take the retrieved message and put a preselected number of duplicate messages in each target queue (e.g., MD5 queues). In one embodiment, the preselected number is 5. In such case, the target queue or client download queue will get five message/address links to a single client computer having the particular download file. The process can manage (240) the SPN Monitor application and associated user interface by updating the appropriate tables and user interfaces. Before populating the download queues, the process determines (242) whether the target queue is present. If not, the process logs (244) an error and determines (246) whether the current message is the last message of the ten messages. If it is not the last message, the process returns to determining (238) the target queue name for the next message. If it is the last message, the process returns to determining (232) whether the thread is live.

Returning to (242), if the target queue is present, the process determines (248) whether the IP address for the client computer in the message is a local IP address rather than a real IP address. If it is not a local IP address, then the process sends (250) the message (IP, Port) five times to the target (MD5) queue. After (250) or if the IP address is local, the process then determines (252) whether a source IP address is present. If not, then the client making the current message got the downloaded file from the cloud storage and the process returns to determining (246) whether the current message is the last message of the ten messages. If the source IP address is present, then the client making the message got the downloaded file from a client computer and the process adds one message for the source client (Src-IP, Src-Port) back to the queue to maintain the roughly 5 message entries per available download client. The process then returns to determining (246) whether the current message is the last message of the ten messages.

The ten messages processed at a time and five messages copied per download queue are preselected values for effective queue download control. In several embodiments, these parameters are predetermined for the system or based on empirical results to achieve a particular performance goal. In one embodiment, the performance goal is a minimum of 99 percent download by client computers rather than by cloud storage. In such case, usage of cloud storage for download files is minimized along with the associated virtual machines for facilitating the downloads. Each of these cloud components can be charged on a per unit and/or per time basis. So proper queue management can result in cost efficiency. In other embodiments, the system parameters can be modified to suit other performance goals.

In one embodiment, the process can perform the sequence of actions in any order. In another embodiment, the process can skip one or more of the actions. In other embodiments, one of more of the actions are performed simultaneously. In some embodiments, additional actions can be performed.

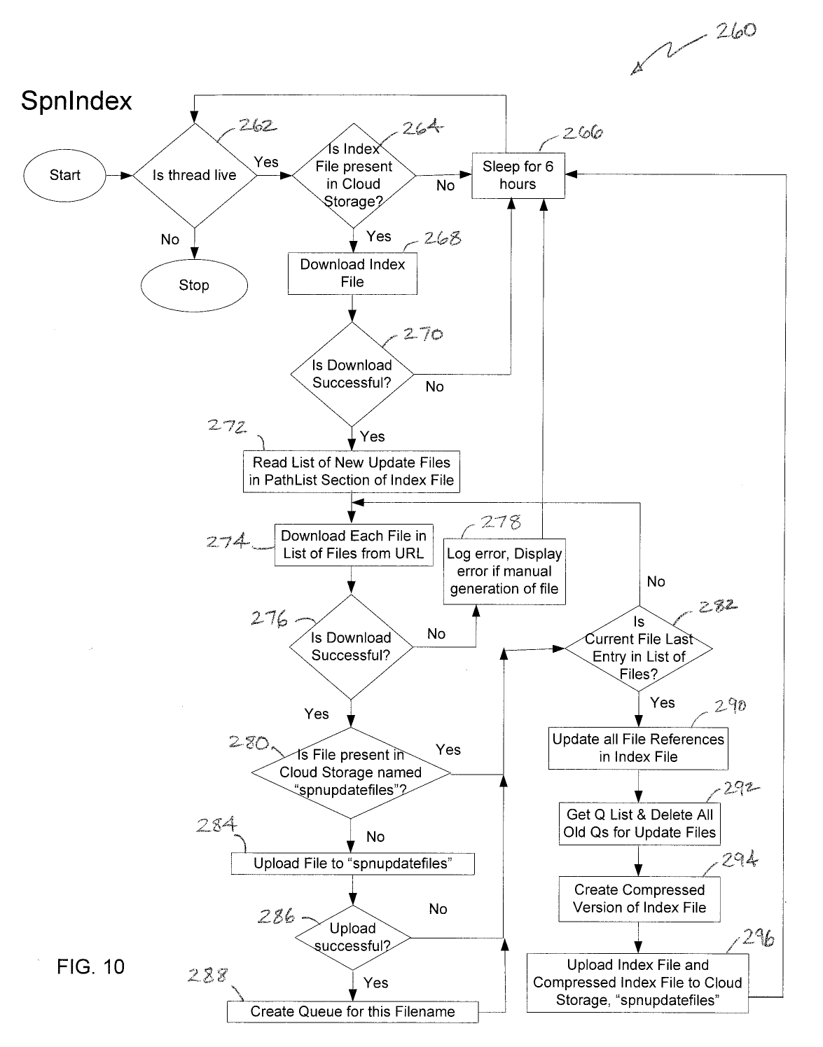

FIG. 10 is a flowchart illustrating an secure peer network (SPN) index process 260 that can be performed on a cloud virtual machine in accordance with one embodiment of the invention. The process first determines (262) whether the SPN Index thread is live. If it is not, then the process stops. If the thread is live, the process determines (264) whether the update index file is present in cloud storage. If it is not present, then the process can sleep (266) for six hours. In such case, the cloud service provider may be having problems so the process waits for the six hour period to allow the service provider to recover. In other embodiment, the process can wait more than or less than six hours.

If the update index file is present, then the process downloads (268) the index file and determines (270) whether the download was successful. If not, the process sleeps (266). If the download was successful, the process reads a list of new update files in a Pathlist section of the index file. In several embodiment, the pathlist section of the index file can be updated manually by an operator or system administrator having updated a definition or executable file for distribution. For each file in the list of files, the process can download (274) the file from the corresponding URL listed in the pathlist section and determine (276) whether the download was successful. If not, the process can log and display (278) an error and return to sleeping (266). If the file download was successful, the process can determine (280) whether the file is already present in the cloud storage bucket “spnupdatefiles”. If so, the process can divert to determine (282) whether the current file is the last in the list of files. If it is not the last file, the process returns to downloading (274) each file of the list of files.

Returning to (280), if the file is not present in cloud storage bucket “spnupdatefiles”, then the process uploads (284) the file to the “spnupdatefiles” bucket. The process then determines (286) whether the upload was successful. If not, the process returns to checking (282) for the last file. If the upload to the “spnupdatefiles” bucket was successful, the process creates (288) a new queue for this filename process returns to checking (282) for the last file. If the current file is the last file in the list of files, the process updates (290) all file references in the index file. The process then gets (292) a queue list and deletes all of the old download queues for update files. In several embodiments, the process considers that if the update files are obsolete, the process does not want client computers accessing or downloading the old update files from these queues. The process then creates (294) a compressed and encrypted version of the index file. The process then uploads (296) the index file and the compressed version to cloud storage bucket “spnupdatefiles”, where it can be accessed by cloud storage applications and the client computers.

In one embodiment, the process can perform the sequence of actions in any order. In another embodiment, the process can skip one or more of the actions. In other embodiments, one of more of the actions are performed simultaneously. In some embodiments, additional actions can be performed.

FIG. 11 is a schematic block diagram showing the flow of data across components of the VirusAdmin system 118 and a client computer 106 of FIG. 3. The Virus Admin system 118 includes the tovirusadminrisklist queue 128, the tovirusadminapphunter queue 130, an alertuploadfiles bucket 300, a riskmd5table table 302 or Risk Table, and a virusmd5table table 304 or Virus Table. In a number of embodiments, the VirusAdmin cloud storage components are created by the VirusAdmin application. The VirusAdmin system 118 also includes multiple threads including a Virus upload thread 306, a Virus check thread 308, a Virus hunter thread 310 or AppHunter, and a Update Virus Table thread 312 that access and control the Virus Admin data structures described above. The client computers 106 access the alertuploadfiles bucket 300, tovirusadminrisklist queue 128, the Risk Table, and the Virus Table as previously described in the description of FIG. 8 above.

FIG. 12 is a schematic block diagram showing the flow of data in and out of the VirusAdmin system of FIG. 11 in accordance with one embodiment of the invention. The Virus Update thread can read data from the virus table 305 and an external alert server 314. The Virus Update thread can then generate updated virus definition files and upload them to appropriate cloud storage and external storage such as the master file repository 316. In one embodiment, the external alert server 314 is a server collecting virus data from a secure peer to peer network not involving cloud services. The Virus Hunter or AppHunter thread can scan suspicious files and publish the information to the virus table. The Virus Check thread can download suspicious file information from the tovirusadminrisklist queue 128 and alertuploadfiles bucket 300. The Virus check thread can also initiate an AppHunter scan by placing a message in the tovirusadminapphunter queue 130 and/or update the suspicious file database or Risk Table 302.

While the systems and methods described herein are sometimes indicated to operate on suspicious files and virus files, in many embodiments, the files processed and exchanged are signature files which are compressed and encrypted for a number of reasons. These reasons include reducing network bandwidth, storage requirements and maintaining system integrity by encrypting files. In several such embodiments, a MD5 hash code is used for the encryption.

In one embodiment, a TPNReport program runs on a client computer assigned by the TPNReportAdmin program. In such case, TPNReport uses the in the cloud databases, file storages and queues to display the system statistics and manipulate any threat data with a graphical user interface.

In one embodiment, Admin reporting software enables viewing of statistics data, reporting of suspicious threat data or files, adding or removing the threat data. Also, the Admin reporting software enables querying threat analysis reports and initiating new crawl websites of the cloud databases, cloud storages and cloud queues via the Internet connection.

In some embodiments, admin reporting software can set policies to assign dedicated client computers run TPNReport. It can also set policies using dedicated IP addresses and/or with passwords. The admin reporting software could also set multiple passwords for TPNReport users for the certain functions such as deleting the threat signature data for false positive processing.

In a number embodiments, a queue is generated for each file that is to be distributed. For example, each known threat file could have its own queue. Similarly, each new threat definition file or threat database file for client use could have its own queue. In a number of such embodiments, the queue name can correspond to a file signature. In some embodiments, the traditional function of a queue is modified to act as a list or table or another useful data structure. This can be useful in certain situations where it is desirable for data to both be readable in the queue while remaining for future use rather than being deleted.

In several of the illustrated embodiments, one data structure is illustrated. However, several data structures may be used instead for each such occurrence. In addition, in several of the illustrated embodiments, particular numbers of data structures are illustrated. In other embodiments, more than or less than the illustrated number of data structures can be used.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

What is claimed is:

1. A method for distributing files using a cloud for providing computing services, the method comprising:
providing, at the cloud, cloud services comprising a data structure and a virtual machine;
obtaining, from the data structure in the cloud, information comprising at least one location of a file available for distribution;
obtaining, at a client computer, the file from the at least one location.

2. The method of claim 1, wherein the at least one location is a second data structure in the cloud.

3. The method of claim 1, wherein the at least one location is a second client computer.

4. The method of claim 1, wherein the obtaining, at the client computer, the file from the at least one location includes obtaining, at the client computer, the file from a second data structure in the cloud when the file is unavailable from a second client computer.

5. A file distribution system using a cloud for providing computing services, the system comprising:
a cloud coupled to a network, the cloud configured to provide cloud computing services and comprising a data structure and a server application;
a plurality of client computers coupled to the network, each client computer configured to store a request for a file in the data structure;
wherein the server application is configured to retrieve the request from the data structure and to provide, for each client computer requesting the file, information for obtaining the file.

6. The system of claim 5, wherein the information for obtaining the file includes information identifying a second data structure in the cloud configured to provide the requested file.

7. The system of claim 5, wherein the information for obtaining the file includes information identifying a second client computer configured to provide the requested file.

8. The system of claim 7, wherein the server application is configured to provide information identifying a second data structure in the cloud configured to provide the requested file when the file is unavailable from a second client computer.

9. The system of claim 5, wherein the cloud is configured to provide the cloud computing services to a plurality of users via the network.

10. The system of claim 5, wherein the cloud is configured to provide the cloud computing services to a plurality of users via the network at a monetary rate.

11. The system of claim 5, wherein the cloud is configured to provide the cloud computing services to a plurality of users via the network at a monetary rate based on a time period of use of the cloud computing services.

12. The system of claim 5, wherein the cloud is configured to provide the cloud computing services to a plurality of users via the network at a monetary rate based on a count of the cloud computing services used.

13. The system of claim 5, wherein the cloud computing services comprise a service selected from the group consisting of a queue service, a storage service, a database service, and a virtual machine service.

14. The system of claim 5, wherein the cloud computing services comprise a queue service, a storage service, a database service, and a virtual machine service.

15. The system of claim 5:
wherein the cloud computing services comprise a virtual machine service; and
wherein the server application is configured to execute on the virtual machine service.

16. A method for distributing files using a cloud for providing computing services, the method comprising:
obtaining an updated index file from a cloud storage;
parsing the updated index file for at least one name of an updated distribution file;
determining, for the at least one name, whether a queue for the at least one name exists in the cloud;
determining, if the queue exists, whether the queue is empty;
obtaining, if the queue is empty, the updated distribution file from the cloud storage; and
obtaining, if the queue is not empty, the updated distribution file from a client computer.

17. The method of claim 16, wherein the updated distribution file is a threat definition file.

18. The method of claim 16, wherein the updated distribution file is a client application file.

19. The method of claim 16, further comprising sending a message to a second queue, the message indicative of identifying a client computer having successfully obtained the updated distribution file.

20. The method of claim 16, wherein the obtaining, if the queue is not empty, the updated distribution file from the client computer comprises:
obtaining a message from a second queue, the message identifying an address of the client computer;
obtaining the updated distribution file from the client computer using the address.

21. The method of claim 16, further comprising reading a backoff value stored in a second cloud storage, wherein the backoff value is a signal for a client computer to temporarily halt attempts to obtain files.

22. A file distribution system using a cloud for providing computing services, the system comprising:
a cloud coupled to a network, the cloud configured to provide cloud computing services and comprising a data structure and a server application having a file storage;
a plurality of client computers coupled to the network, each client computer configured to communicate a request for a file to the data structure;
wherein the server application is configured to respond to the request by providing information identifying at least one of the plurality of client computers having the file;
wherein each of the plurality of client computers is configured to obtain the file from the identified client computer;
wherein a first client computer of the plurality of client computers is configured to obtain the file from the file storage if the first client computer is unable to obtain the requested file information from the identified client computer.

23. The system of claim 22, wherein the file is a threat definition file.

24. The system of claim 22, wherein the file is a client application file.

25. The system of claim 22, wherein each client is configured to send a message to a second queue, the message indicative of identifying a client computer having successfully obtained the updated distribution file.

26. The system of claim 25, wherein the server application is configured to duplicate the message a preselected number of times and place the duplicated messages in a third queue.

27. The system of claim 26, wherein the preselected number is used to achieve a preselected efficiency defined by a use of client computers for file downloads rather than a use of the file storage in the cloud for file downloads.

28. The system of claim 22, further wherein each client is configured to read a backoff value stored in a second cloud storage, wherein the backoff value is a signal for a client computer to temporarily halt attempts to obtain files.
